(19) United States
(12) Patent Application Publication
(10) Pub. No.: US 2010/0143574 A1
(43) Pub. Date: Jun. 10, 2010

(54) Pet wrapping paper

(76) Inventor: Aaron Ian Guilmette, Nashville, TN (US)

Correspondence Address: Aaron Ian Guilmette, 6021 Deer Trace, Nashville, TN, 37211, US

(21) Appl. No.: 12/586,606

(22) Filed: Jan. 5, 2010

Related U.S. Application Data
(60) Provisional application No. 61/100,250, filed on Sep. 25, 2008.

(51) Int. Cl. A23L 1/22

(52) U.S. Cl. 426/650

(57) ABSTRACT

The present invention is a flavored wrapping (gift wrapping) paper designed and intended to be attractive to pets. This pulp wood or cellulose based paper product is flavored and or scented for the pets consumption and enjoyment. Invention is intended to wrap gifts that pets will then unwrap. Invention is a pet wrapping paper, for pets to tear apart, play with, and eat.

### TECHNICAL FIELD

The present invention relates to a form of flavored wrapping paper designed to be attractive to pets.

### BRIEF DESCRIPTION OF THE DRAWINGS

FIG. 1 shows examples of flavored wrapping paper in roll and flat form.

### DETAILED DESCRIPTION OF EXEMPLARY EMBODIMENTS

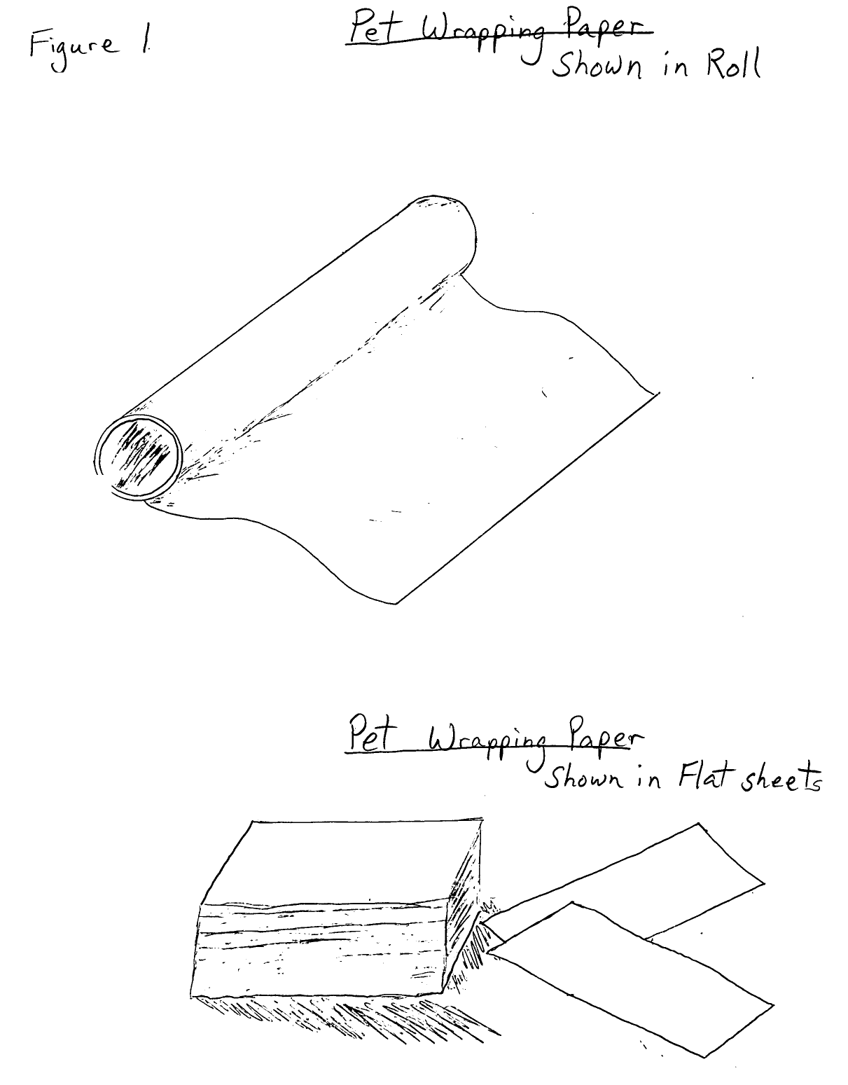

FIGS. 1 shows examples of wrapping paper in rolled and flat form in accordance with one exemplary embodiment of the present invention. The wrapping paper is for use with pets, including, but not limited to, dogs and cats, to wrap, cover, fold over, protect, or otherwise enwrap an object, including but not limited to a box, product, gift, treat, toy, or present. The wrapping paper is flavored and/or scented with flavors and/or scents attractive to pets, or particular types of pets. The wrapping paper may also be textured or have an appearance to enhance its attractiveness to pets. Accordingly, the wrapping paper may be used to wrap an object to give to a pet, which is attracted to the object by the flavor and or scent of the paper, and “unwraps” the wrapped object by itself. The dog, cat, or other pet is attracted by the scent, taste, texture, and/or appearance, and by example or by nature tear apart, eat, play with, bury, hide, or otherwise “unwrap” the wrapped object.

The wrapping paper may be used to wrap or prepare a present for the pet itself, such as a birthday present, Christmas present, or gift. The wrapping paper may also be used to wrap or prepare a present for the pet owner, or other person who may or may not want a pet to “open” the wrapped object (i.e., the wrapping paper may be used as a joke or gag item).

The wrapping paper can be made of any material currently used to make wrapping paper known in the art, with additional flavor and/or scented ingredients added anywhere in the pulping or papermaking process as an internal or external filling, filler, or sizing. Flavoring and/or other ingredients also can be pressed, sprayed on, baked in or on, dried in or on, or otherwise infused into the base material or paper. Base material can be pulp wood, hemp, cellulose, cardboard, paper, or any other organic, manmade or artificial material or product used to make wrapping paper. Ingredients can include, but are not limited to, the following and their byproducts: pulp wood, cellulose, starch, tapioca starch, corn starch, wheat starch, mixed tochopherols, vitamin E, rice, barley, oatmeal, canola oil, peanuts, vanilla, chocolate, carob, chicken, beef, pork, cinnamon, catnip, turmeric, natural and artificial flavors and/or colors, caramel colors, and the like.

Thus, it should be understood that the embodiments and examples have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

1) I claim a paper comprising natural flavoring.

2) The paper of claim 1, further comprising natural scent, such that when the paper is introduced to pet, pet is attracted.

3) The paper of claim 1, further comprising artificial scent, such that when the paper is introduced to pet, pet is attracted.

4) The paper of claim 1, further comprising texture, such that when the paper is introduced to pet, pet is attracted.

5) I claim a paper comprising artificial flavoring.

6) The paper of claim 5, further comprising natural scent, such that when the paper is introduced to pet, pet is attracted.

7) The paper of claim 5, further comprising artificial scent, such that when the paper is introduced to pet, pet is attracted.

8) The paper of claim 5, further comprising texture, such that when the paper is introduced to pet, pet is attracted.

9) I claim a paper comprising scent, such that when the paper is introduced to pet, pet is attracted.

10) The paper of claim 9, further comprising texture, such that when the paper is introduced to pet, pet is attracted.
